(19) United States
(12) Patent Application Publication
(10) Pub. No.: US 2017/0217809 A1
(43) Pub. Date: Aug. 3, 2017

(54) CONTINUOUS-PROCESS MOBILE WATER TREATMENT STATION

(71) Applicant: Armada Water Assets, Inc., Houston, TX (US)

(72) Inventors: Oliver Laurence, Austin, TX (US); Barry Hinton, Loveland, CO (US); Ed Keenan, Indio, CA (US); Jake Nelson, Grand Junction, CO (US); Zach Donaldson, Windsor, CO (US); Shawn Lesmeister, Rozet, WY (US); Mark Stanley, Houston, TX (US)

(21) Appl. No.: 15/422,011

(22) Filed: Feb. 1, 2017

Related U.S. Application Data
(60) Provisional application No. 62/290,694, filed on Feb. 3, 2016.

(51) Int. Cl. C02F 9/00; C02F 1/00; C02F 1/40

(52) U.S. Cl. CPC C02F 9/005; C02F 1/40; C02F 1/004; C02F 1/008; C02F 2201/007; C02F 2201/008; C02F 2101/32

(57) ABSTRACT

Provided are systems and methods for treating wastewater with a continuous-process mobile station. The mobile station may include one or more mobile units configured to receive a feed of wastewater. The one or more mobile units may include: a mobile ozonation unit configured to treat the received feed of wastewater with ozone gas to breakdown impurities in the wastewater, a pH control unit may be configured to raise pH of the treated wastewater, a mobile electrocoagulation unit configured to separate solids and metals from the treated wastewater, a mobile flocculation unit configured to cause suspended particles to form flocs and to remove the flocs from the received treated water.

### CROSS-REFERENCE TO RELATED APPLICATIONS

The present application claims the benefit of U.S. Provisional Patent Application 62/290,694, filed 3 Feb. 2016, titled CONTINUOUS-PROCESS MOBILE WATER TREATMENT STATION, the entire contents of which are hereby incorporated by reference.

### BACKGROUND

1) Field

The present invention relates generally to fluid-processing and, more specifically, to systems and methods for treating wastewater with a continuous-process mobile station.

2) Description of the Related Art

Wastewater presents issues in a number of industries. For instance, wastewater resulting from oil and gas production may contain substances that might need to be removed to comply with certain environmental regulations. Such contaminants may include oil, dissolved metals, salts, breakers, gels, chemical additives, bacteria, viruses, organic and inorganic matter, or other contaminants. Wastewater from other industries, such as printing, electroplating, and leather tanning, similarly also includes contaminants that are desirable to remove.

In some types of wastewater treatment, wastewater is transported to a wastewater treatment plant to be treated, or such a plant may reside on-site. Once the wastewater is treated, the water is often transported again to be disposed of or reused. If the treated water is reused, often times the water is reused in the same industry that produced the water. For example, flow back from hydraulic fracturing may be re-used in hydraulic fracturing once the water is treated. To accommodate reuse, the water may be transported to a fixed-based treatment site to be treated and returned back to an oil field. Transporting the water can be expensive and slow.

Compounding this issue with transport, many water treatment applications are transient, lasting for a few days or weeks at a time for a given location, in some cases. Often wastewater will be produced by a one-time event at a given location, e.g., following in industrial chemical spill, or during a period of flow-back following hydraulic fracturing of a well. Or in some cases, waste water treatment capacity will be needed for longer, but still temporary durations, for instance, to process salt water produced with oil and gas.

Existing techniques to treat wastewater are not suitable for many remote wastewater treatment use cases, such as those occurring in oil fields. Many existing techniques rely upon power infrastructure absent in the field, are too large and cumbersome to service in the field, are not suitable for transient mobile deployments in the field, or are incapable of processing commercially relevant flowrates (e.g., between 1 to 10 thousand barrels a day, like between 3 and 5 thousand barrels a day). This is not to suggest that every embodiment described below addresses every one of these problems, or that embodiments do not address other issues described below.

### SUMMARY

The following is a non-exhaustive listing of some aspects of the present techniques.

These and other aspects are described in the following disclosure.

Some aspects include a continuous-process mobile station for treating wastewater. The mobile station may include one or more mobile units configured to receive a feed of wastewater. The one or more mobile units, in these aspects, may include a mobile ozonation unit configured to treat the received feed of wastewater with ozone gas to breakdown impurities in the wastewater. The one or more mobile units may further include a mobile pH control unit configured to be fluidly coupled with the ozonation unit. The pH control unit may be configured to raise or lower the pH of the treated wastewater. The one or more mobile units, in these aspects, may further include a mobile electrocoagulation unit configured to be fluidly coupled with the pH control unit. The electrocoagulation unit may be configured to receive the treated wastewater from the mobile pH control unit. The mobile electrocoagulation unit may include one or more pairs of electrodes and an insulating material. The mobile electrocoagulation unit may be configured to separate solids and metals from the treated wastewater. The one or more mobile units may further include a mobile flocculation unit configured to be fluidly coupled with the electrocoagulation unit. The flocculation unit may be configured to receive the treated wastewater from the electrocoagulation unit, where suspended particles are caused to form flocs. The mobile flocculation unit may be configured to separate the flocs from the received treated water.

Some aspects include a process for treating wastewater using a continuous-process mobile station. The mobile station may include one or more mobile units configured to receive a feed of wastewater. The one or more mobile units may include a mobile ozonation unit, a pH control unit, a mobile electrocoagulation unit, a mobile flocculation unit, and a solids/liquids separation unit. The method includes treating, with the mobile ozonation unit, the received feed of wastewater with ozone gas to breakdown impurities in the wastewater. The method may further include raising pH of the treated wastewater with the pH control unit. The method may further include receiving the treated wastewater from the mobile pH control unit, and separating solids and metals from the treated wastewater with the electrocoagulation unit. The method may further include receiving the treated wastewater from the electrocoagulation unit, causing suspended particles to form flocs with the flocculation unit and separating the flocs from the received treated water.

### BRIEF DESCRIPTION OF THE DRAWINGS

The above-mentioned aspects, and other aspects of the present techniques, will be better understood when the present application is read in view of the following figures in which like numbers indicate similar or identical elements:

FIG. 1 shows an example of a continuous-process mobile station for treating wastewater;

FIG. 2 shows an example of a mobile ozonation unit, in accordance with some implementations of the system of FIG. 1;

FIG. 3 shows an example of a mobile oil separator unit, in accordance with some implementations of the system of FIG. 1;

FIG. 4 shows a mobile electrocoagulation unit, in accordance with some implementations of the system of FIG. 1;

FIG. 5 shows a mobile flocculation unit, in accordance with some implementations of the system of FIG. 1; and

FIG. 6 shows an example of a method for using a continuous-process mobile station.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

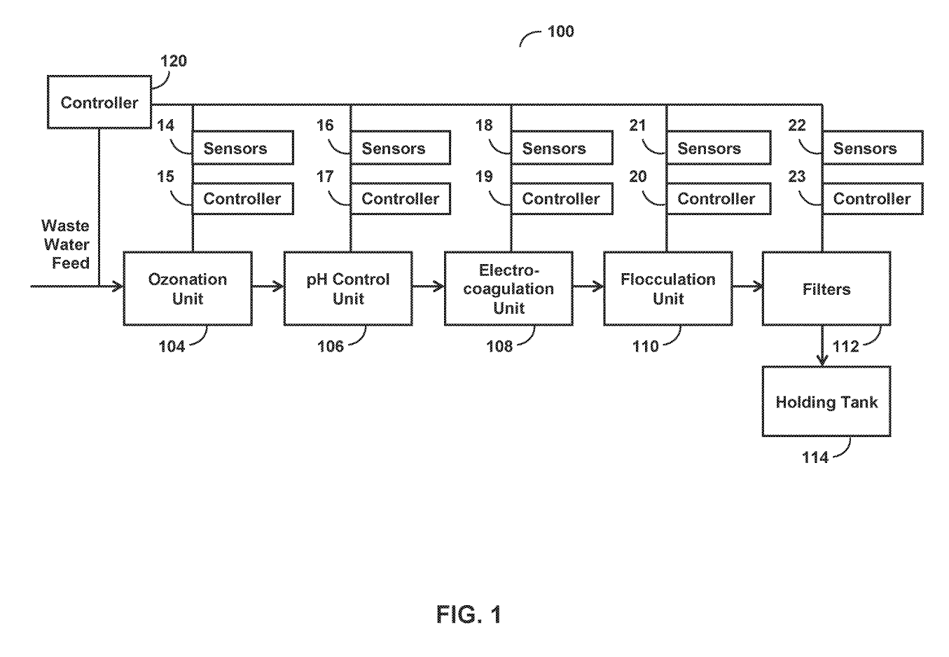

FIG. 1 illustrates an example of a continuous-process mobile station 100 for treating wastewater. In some embodiments, the continuous-process mobile station may treat water from different origins, for example, mining industries, metal processing industries, pulp and paper industries, the oil industry, and other producers of waste water. In some embodiments, the station is mobile and, as such, provides temporary water treatment capacity at remote sites of production (for example, an oil or gas well). Having access to wastewater reduces the need and cost of transportation, as the waste water produced from one well may be re-used at another, nearby well (e.g., for hydraulic fracturing of that well), or if properly treated, used in other proximate applications (e.g., in agriculture). In some cases, mobility is enhanced by a containerized modular configuration of some embodiments, a feature which is expected to facilitate transport of the station's component units and appropriate sizing and configuration for different wastewater flowrates and compositions at different locations. It should be noted, though, that not all embodiments necessarily provide all of these advantages, as the various features are independently useful.

In some embodiments consistent with FIG. 1, a continuous-process mobile station 100 for treating wastewater may include one or more mobile units configured to receive a feed of wastewater 102. The one or more mobile units may include a mobile ozonation unit 104, a mobile pH control unit 106, a mobile electrocoagulation unit 108, a mobile flocculation unit 110, a mobile filtration unit 112.

Wastewater may come from a variety of sources. In some cases, wastewater is flow back water originating from hydraulic fracturing activity.

In some embodiments, wastewater is produced water from oil and natural gas production. In some embodiments, wastewater is water originating from other one or more of industrial activities, commercial activities, domestic activities, agricultural activities, or the like. In some cases, the composition of dissolved metals and salts and flow rates may depend upon the geology of an oil or gas well from which waste water is received. In some cases, produced water may pass from the oil or gas well to an oil-water separation unit (e.g., a tank operative to separate oil and water based on density, with outlets at different depths for water and oil) and, then, into the station 100. In some embodiments, wastewater may contain pathogens, organic matter, inorganic matter, gases, salts, heavy metals, radioactive components, or other types of waste.

The illustrated station 100 is suitable for continuous process applications. The term “continuous” is not used to mean that the process operates without any interruption ever, for instance, without shutting down at night. Rather, the term “continuous” serves to distinguish the process from batch processes, for instance, as might be performed on a laboratory bench or by systems like those described in PCT Patent Application 14/180,521. These batch processes are generally not suitable for the flow rates encountered in many commercial use cases, for instance, flow rates in the range of 750-2,500 bbls per day per well occurring over the first 30-60 days of production encountered in flowback from hydraulic fracturing activities during oil and gas production. In some cases, production water, associated with oil and gas production, may be in the 20-80% of production range of the entire flow originating from a producing well, depending on the age of the producing well. For example, a producing well may start with a low water cut (3-5%) and may increase to up to 95% over the lifetime of the producing well. In some embodiments, wastewater concurrently flows through various processes described below, in some cases without substantial accumulation between processes, like in a holding pond. That said, some embodiments are consistent with batch processes, as various engineering challenges addressed, and those solutions are applicable in a variety of scenarios. In some embodiments, the mobile station 100 may operate without interruption for a substantial duration, e.g., 24 hours per day, seven days per week, for one or more weeks. In such use cases, the infrequent shutdowns may be for scheduled maintenance, process modifications, equipment additions, equipment removal, safety checks, or other shutdowns for other reasons where the process is stopped. In some embodiments, the flow of water through the continuous-process mobile station 100 may be interrupted, e.g., during a shutdown. For example, the shutdowns may occur daily. In some embodiments, parts of the process are interrupted while other parts of the process are continuing. For example, the wastewater may pass through a holding pond or tank between processing by the various units of the station 100. In some embodiments, the operations of the treatment process are in sequence. In some cases, the flow rate through each stage of the sequence may be concurrently substantially equal, or some embodiments may include storage capacity between units. For example, in some embodiments, the process of treating wastewater may be stopped until a chemical reaction or other processes are finished before resuming the process.

In some embodiments, the station 100 may be a mobile station configured to be moved from one location to another location. Various attributes may contribute to mobility, depending upon the application. In some cases, modularity, size, and electrical power efficiency of the units described below may facilitate movement between temporary deployments in remote rural areas. That said, some embodiments are immobile, as some of the techniques described herein have applicability in fixed water treatment plants.

In some embodiments, the mobile station may be moved by trucks to facilitate wastewater treatment at a location where wastewater is produced or near a location where treated wastewater is consumed. Some embodiments may be sized such that all units in the station 100 may fit on a single truck to facilitate remote, low-cost deployments, and the units may be modular to facilitate staged removal from the truck in remote areas in which larger cranes are unavailable. In some embodiments, the mobile station may be unloaded by a forklift or small crane. In some embodiments, one or more units of the mobile station may be separately unloaded by a forklift or small crane. In some embodiments, individual units may be skid mounted and/or containerized. In some embodiments, station 100 may include one or more units that are not mobile, as various other engineering problems are addressed by the present techniques and are independently useful. In some embodiments, the units may be sized such that the units can be moved by other vehicles, such as cars, trains, boats, planes, or the like.

To facilitate movement (e.g., in to remote rural areas with low-quality roads), some embodiments may be sized to accommodate various types of transport. In some embodiments, one or more mobile units 100 may include one or more containerized modular units. For example, one or more mobile units 100 may be configured to fit in a standard shipping container for easy movement, such standard being specified by “ISO 668:2013 Series 1 freight containers—Classification, dimensions and ratings” and “ISO 1496-1:2013 Series 1 freight containers—Specification and testing—Part 1: General cargo containers for general purposes.” In some embodiments, one or more mobile units may be configured to fit in a non-standard shipping container having uncommon size and dimensions. In some embodiments, one or more mobile units may have a volume that is smaller than the volume of a standard shipping container. In some embodiments, more than one mobile unit may fit in a standard shipping container. In some embodiments, continuous-process mobile station 100 may be configured to fit in a standard shipping container. In some embodiments, one or more mobile units 100 may be configured to have a volume up to a volume that is 30% more than a volume of a standard shipping container. As used herein, a standard shipping container may include containers having exterior dimensions that may vary between 10 and 53 feet in length, between 8 and 10 feet in height, and about 8 feet in width. Standard shipping containers may refer to containers having interior dimensions that may vary between 9 and 52.5 feet in length, between 7 and 9 feet in height, and between 7 and 7.75 feet in width. Standard shipping containers may refer to containers having an internal volume between 500 ft³ and 3500 ft³.

In some embodiments, one or more units of continuous-process mobile station 100 may be transported in custom made receptacles. In some embodiments, the one or more mobile units may be transported without a receptacle or a container. For example, one or more units may be configured to be compact and having a size small enough to fit in the back of a truck with no need of a container.

In some embodiments, one or more mobile units within continuous-process mobile station 100 may be constructed and arranged as a modular process skid. A given mobile unit constructed and arranged as a process skid may be contained within a structure sized and shaped for relatively easy access, transportation, connection to other components of continuous-process mobile station 100, among other advantages. In some embodiments, individual ones of the one or more mobile units are configured to be arranged as process skids fluidly coupled to one another to form continuous-process mobile station 100. In some embodiments, fluidly coupled can include being permanently coupled, e.g., in a single unit, or being modular and separate units coupled on site. In some embodiments, the process skids may include all components needed for the individual mobile unit operations. For example, in some embodiments, a given process skid may include tanks, pipes, pumps, controllers, sensors, power supply, connectors, or other components needed for the individual mobile unit operation. In some embodiments, a given mobile unit in continuous-process mobile station 100 may be configured to include multiple skids configured to be combined to perform the process of the given mobile unit.

In some embodiments, skids may be sized to facilitate transportation and manipulation by equipment available in remote, rural areas. for example skids may be housed within multiple standard containers or containments, which facilitate easy deployment using non-specialist moving and unloading equipment (for example, using moving, loading and/or unloading equipment used with conventional shipping containers.

Existing, fixed water treatment plants cannot be made mobile merely by mounting those processes on structures having the above dimensions. Conventional fixed water treatment plants use methodologies that rely on large volumes of water being treated using large settling and aeration ponds. Often, theses treatment plants use a biological treatment methodology that is not generally appropriate for industrial waste water. Such plants often consume much more electrical power per unit of treated water flow than is generally available in remote deployments. For instance, some membrane treatment techniques use relatively large, difficult to transport pumps and filters and consume relatively large amounts of electrical power, rendering such systems unsuitable for some more difficult to reach rural deployments. Existing electrocoagulation-based treatment plants are similarly too power-inefficient for remote deployment or only provide acceptable results when used in a batch process. That said, some embodiments may use these techniques in combination with other inventive aspects of the present disclosure, as the techniques described herein are independently useful.

In some embodiments, one or more mobile units of station 100 may be configured to be coupled to one another in fluid communication. In some embodiments, one or more mobile units of station 100 may be configured to be coupled in series. In some embodiments, “in series” configurations may include one or more parallel units at individual steps of the series, and some steps may be repeated serially along a flow path. For example, one or more mobile units of station 100 may be configured to include two or more ozonation units, arranged in parallel, and both coupled in series with electrocoagulation unit 108. The one or more mobile units may be removably coupled to one another. For instance, the units may be fluidly coupled by resilient tubes through which treated water passes, and the units may be electrically coupled by wires. In some embodiments, the continuous-process mobile station 100 may be configured to be fluidly coupled to an oil well, e.g., via an oil-water separation unit (which is different from the type of water treatment described herein, e.g., to remove metal contaminants, among others, though such treatment may also include oil-water separation) or a liquids holding pond. For example, continuous-process mobile station 100 may be configured to access wastewater directly from an oil well where wastewater is produced without having to otherwise move the wastewater to continuous-process mobile station 100.

In some embodiments, continuous-process mobile station 100 may be configured to treat commercially relevant flow rates, e.g., a quantity of wastewater of more than 40,000 gallons of wastewater per day. In some embodiments, continuous-process mobile station 100 may be configured to treat a quantity of wastewater over 140,000 gallons of wastewater per day. For example, continuous-process mobile station 100 may be configured to be scaled down, by removing some components, to treat for example 40,000 gallons per day. In some embodiments, continuous-process mobile station 100 may be scaled up, by adding more components, to treat for example 700,000 gallons per day.

Mobile ozonation unit 104 may be configured to treat the received feed of wastewater with ozone gas. Mobile ozonation unit 104 may be configured to treat the wastewater by injecting and infusing the wastewater with ozone. Ozone, O₃, is pale blue gas having three oxygen atoms and no hydrogen. Of relevance to the present embodiment, ozone gas is a relatively powerful oxidant. In operation, an ozone molecules tries to go back to its original form of O₂ by releasing the extra oxygen atom, which in turn binds with oxidizeable matter present in the wastewater. Ozonation of the wastewater may facilitate breaking down impurities such as organics in the wastewater. For example, ozonation of wastewater is expected to facilitate dissolving metals, breaking down organic and inorganic matter, killing bacteria, and other chemical decomposition.

As a highly-unstable gas that decomposes quickly, ozone generally cannot be stored before use. In some embodiments, ozone is produced on site, e.g., just before use, for instance, within 60 seconds of exposure to wastewater. In some embodiments, the mobile ozonation unit 104 may include one or more ozone generators. In some embodiments, the ozone generators may be included in continuous-process mobile station 100 but outside of mobile ozonation unit. In other embodiments, the ozone generators may be outside of continuous-process mobile station 100. Examples of ozone generators include corona discharge ozone generators, ultra violet (UV) ozone generators, cold plasma ozone generators, electrolytic ozone generator, and other types of ozone generators. In some embodiments, ozone generated may vary in concentration between 0.5-30% concentration depending on the type of generator. The effectiveness of ozone generation may depend on the concentration of oxygen in the feedstock to the ozone generator and the type of ozone generator being used. The range and concentration of the ozone may dependent on the oxygen feed gas. In some embodiments, concentration of the ozone may vary between 3-8%. Dosage rates of the ozone into the wastewater may depend on the level of organics in the wastewater and control of this dosing may be driven by Oxidation Reduction Potential (ORP) of the incoming wastewater vs the desired “output” ORP levels via a PID loop control system. For example, some embodiments may include a corona discharge ozone generator that produces ozone with 3-8% concentration, or an electrolytic ozone generator that produces ozone with 20-30% concentration.

For example, a corona discharge ozone generator may include two electrodes separated by a dielectric and an air gap. An alternating electric current may be applied to the electrodes creating an electrical discharge and air enriched oxygen may be passed through the air gap. The ozone generator may be configured to direct air enriched oxygen through the air gap and the electrical discharge, which may convert a portion of the oxygen to ozone. A corona discharge ozone generator may produce ozone gas with concentrations of 3 to 8%. In some embodiments, the ozone generator may be configured to produce of up to 6 ppm of dissolved ozone in water. ORP levels of incoming water streams may be variable and the amount of dissolved ozone required to reach particular set points of ORP, to ensure an appropriate oxidative environment, may vary accordingly.

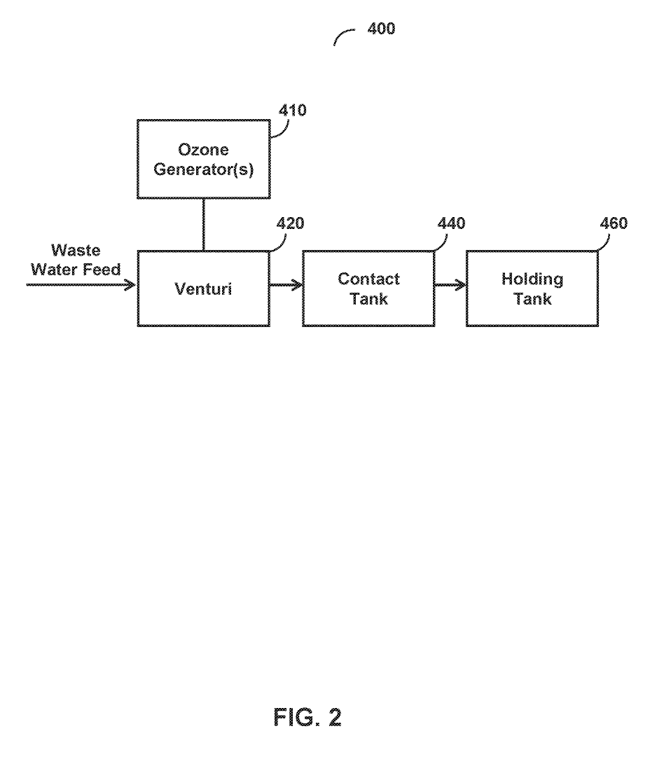

FIG. 2 shows an example of ozonation unit 400 according to one configuration. In this example, ozonation unit 400 includes an ozone generator 410 configured to generate ozone gas. Ozone generator 410 may be configured to generate gas from ambient air, from concentrated oxygen, or from other sources. Venturi 420 may be configured to inject ozone gas into the wastewater feed and facilitate mixing of the ozone gas and the wastewater. In some embodiments, the ozonation unit may include a tortuous flow path for mixing ozone with the wastewater. Contact tank 440 may be configured to facilitate breaking down O₃ molecules and disposing of resulting excess O₂. Holding tank 460 may be configured to receive the ozone treated wastewater. Holding tank 460 may be sized to provide a dwell time of between for example between 5-20 minutes within the tank. In some embodiments, the holding tank may be pressurized at between 20 to 70 psi, e.g., between 40 to 50 psi (gauge pressure), to facilitate infusion of ozone, as the solubility of ozone is expected to increase as pressure increases. Higher pressures are expected to create higher loads that add to cost (though some less cost-sensitive applications may operate at higher pressures). In some embodiments, ozonation unit 400 may include an injection pump configured to inject the ozone gas at a pressure drop of between 20 and 70 psi to facilitate ozone and water mixing. In some embodiments, the treated wastewater from holding chamber 460 may be fed to venturi 420 for re-treatment with ozone gas. It should be noted that an ozonation unit, like the other components described herein, may be configured and many different ways, and may include other components other than the ones shown in FIG. 2.

As shown in FIG. 1, in some embodiments, continuous-process mobile station 100 may include one or more sensors for measuring ozone concentration or ozone activity in the wastewater. The sensors may include oxidation reduction potential (ORP) sensors, which may be configured to output signals indicative of the oxidation reduction potential of the wastewater, e.g., after ozonation, for instance, in the dwell tank or at an outlet of the dwell tank. The ORP sensors may be included in ozonation unit 104 or may be placed upstream or downstream, for example, at an inlet or outlet side of ozonation unit 104.

Continuous-process mobile station 100 may be configured to adjust the wastewater flow rate in response to the ORP measurement, e.g., periodically, like more than once every 60 seconds. In some embodiments, continuous-process mobile station 100 may be configured to adjust wastewater flow rate in response to the OPR measurement being below a value, such as a predetermined set point value or a dynamically determined value, for instance, based on upstream or downstream measured properties, like concentrations of certain metals. For example, wastewater flowrate may be lowered in response of an ORP measurement below 550 millivolts to raise the ORP at the outlet due to increased ozone dosing per unit of water throughput. In some embodiments, continuous-process mobile station 100 may be configured to adjust ozone injection in response to the OPR measurement being below a predetermined or dynamically determined value. For example, with wastewater having a fixed flow rate, ozone injection may be raised in response of an outgoing water ORP measurement below 550 millivolts, and ozone injection may be decreased in response to an outgoing water ORP measurement above this value.

In some embodiments, continuous-process mobile station 100 may further include a feedback controller 15 configured to control one or more parameters of ozonation unit 104. For example, feedback controller 15 may be configured to control ozone parameters based on ORP measurements. Feedback controller may be configured to control parameters of ozonation unit 104 based on other parameters from other components of continuous-process mobile station 100. By way of example, these parameters may include flow rate, pH values, water quality, dissolved ozone, or parameters of continuous-process mobile station 100. In some cases, a microcontroller coupled to a variable pump, adjustable valve, or ozone voltage or current controller may execute proportional control; proportional-derivative control; or proportional-integral-derivative control over the water flow rate or the ozone flow rate in response to measured ORP readings. Feedback controller 15 may be an open-loop type feedback controller, a closed-loop type feedback controller, or other types of controllers. For example, feedback controller 15 may be configured to receive information from sensor 14, compare the information received with one or more values corresponding to the information received, and adjust parameters of ozonation unit based on the comparison between the predetermined values and the measurements from the sensors.

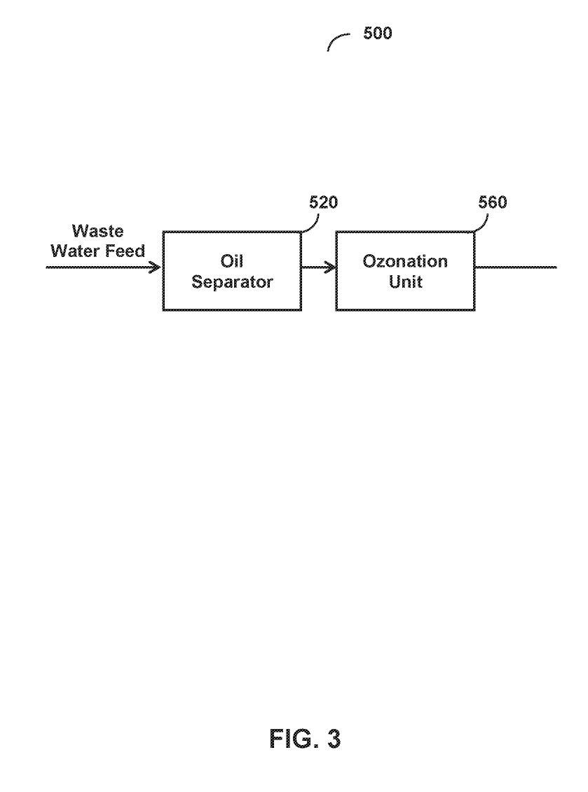

In some embodiments, mobile station 100 may include an oil-water separator unit. FIG. 3 shows an example 500 of an oil-water separator 520 fluidly coupled to ozonation unit 560 on in inlet side of ozonation unit 560. The oil separator unit 520 may be configured to separate oil, grease, hydrocarbons, or suspended solids from the wastewater before the ozonation operation. In some embodiments, the oil separator unit may include an oil-water separator configured to separate the oil and suspended solids from the wastewater. By way of example, the oil-water separator may be configured to separate the suspended solids from the water such that the suspended solids settle to the bottom of the separator. The oil-water separator may include a skimmer configured to skim oil, grease, hydrocarbons, or suspended solids from the surface of wastewater.

As shown in FIG. 1, mobile pH control unit 106 may be configured to be fluidly coupled with the ozonation unit. In some embodiment, pH control unit 106 may be configured to be coupled to an outlet side of mobile ozonation unit 104. PH control unit 106 may be configured to raise pH of wastewater received from ozonation unit 104. By way of example, pH may be raised to to between 8.0 and 9.5 depending on the wastewater constituents. Raising pH of water being treated with continuous-process mobile station 100 is expected to facilitate coagulation and flocculation by decreasing solubility of some heavy metals, which are expected to be enhanced when water being treated is relatively alkaline. Raising pH of the wastewater may be achieved, in some embodiments, by adding caustic substances, such as lime, soda ash, sodium hydroxide, or other chemicals. In some embodiments pH control unit may include, a pH sensor 16, a pH controller 17, a mixing tank, a chemical source tank, or other elements (which is not to imply that any other list of items is exclusive other items that may be included).

In some cases, the wastewater pH may be controlled based on sensor feedback. pH sensor 16 may be configured to measure pH levels in or at an outlet of the mixing tank. pH controller may be configured to receive measurement of pH levels from pH sensor 16, compare the information received with one or more values of pH levels, and adjust parameters of pH control unit based on the comparison between the values and the actual measurements form the sensor. In some cases, a microcontroller coupled to a variable pump, adjustable valve, or current controller may execute proportional; proportional-derivative control; or proportional-integral-derivative control over the water flow rate, source chemical injection rate, or other parameters of pH control unit in response to measured readings from sensor 16. Feedback controller 17 may be an open-loop type feedback controller, a closed-loop type feedback controller, or other types of controllers. Targeted values may be predetermined or determined dynamically, e.g., based on upstream measurement of constituent chemicals, or downstream measurements indicative of coagulation or flocculation amounts.

Mobile electrocoagulation unit 108 may be configured to be fluidly coupled with the pH control unit. In some embodiments, mobile electrocoagulation unit 108 may configured to be fluidly coupled with the ozonation unit or other components of continuous-process mobile station 100. In some embodiments the mobile electrocoagulation unit 108 may be configured to receive the treated wastewater from the mobile pH control unit or other components of continuous-process mobile station 100. In some embodiments, the mobile electrocoagulation unit may include one or more pairs of electrodes submerged in the received wastewater and an insulating material, both shaped to separate solids and metals from the treated wastewater. In some embodiments, separating metals includes separating some but not all the metals. By way of example, mobile electrocoagulation unit 108 may be configured to separate metals ions such as, mercury, lead, arsenic, copper, zinc, selenium, manganese, nickel, and or other metals. Additional ions to be considered include iron, aluminum, chromium, barium, boron. Reductions using electrocoagulation may be in the 40-90% range depending on input concentrations of the metal ions and the metal ion species.

To facilitate metal removal, the one or more electrodes may be configured to release metal ions into the wastewater. Mobile electrocoagulation unit 108 may be configured to apply an electrical charge to wastewater, which is expected to cause a change in the surface charge of particles in the wastewater, which in turn is expected to cause the particles to coagulate as the particles are attracted to one another by the changed surface charge. Electrocoagulation is expected to separate suspended particles in a relatively size and power efficient fashion compared to other techniques (though embodiments are not limited to systems using electrocoagulation, as other features described herein are independently useful). In some embodiments, separating suspended particles includes removing some but not all the suspended particles. Some embodiments may treat water without adding chemicals or using filters at this stage of operations of continuous-process mobile station 100, or some embodiments may supplement the this stage with these techniques.

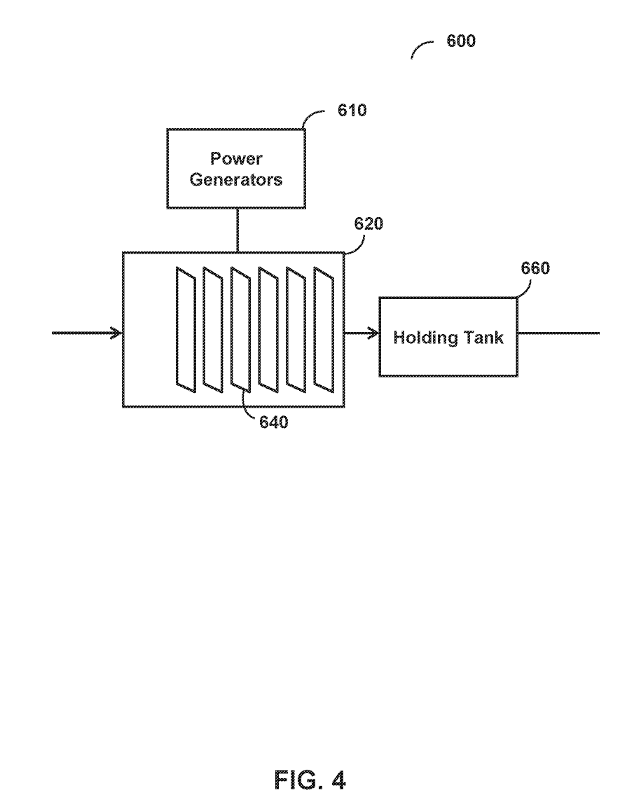

FIG. 4 shows an example of an electrocoagulation unit 600. Electrocoagulation unit 600 may include one or more power generators 610. In some embodiments, power generators 610 may be outside of electrocoagulation unit 600 but within continuous-process mobile station 100. In some embodiments, power generators 610 may be outside of continuous-process mobile station 100. For example, power generators may be local power generators at the site where water treatment is being performed, and continuous-process mobile station 100 plug into the power generators. Generators 610, in some cases, are diesel generators transported to a remote site, having power generating capacity of less than 40-50 kw per 30 gpm

Electrocoagulation unit 600 may include one or more electrode assemblies 640 in tank 620, and a holding tank 660 configured to receive wastewater treated by electrode assemblies 640. The electrode assemblies may include the electrode assemblies described in concurrently filed U.S. patent application [to come when known], titled [to come when known], the entire contents of which are hereby incorporated by reference for all purposes. The electrode assemblies may be arranged in series, in parallel, or a combination thereof. Electrode assemblies 640 may include pairs of electrodes made from conductive metal plates of a material selected in view of the contaminants to be removed. In some cases, the plates in each assembly may be made of the same metal, for instance aluminum (such as 6061 aluminum plate) and iron or steel. Other embodiments may use other materials, such as titanium, graphite, carbon, or other metals. Selection of the appropriate electrode material may depend on material capital cost, operational cost and effectiveness at removing the targeted contaminants. A given set of electrodes includes an anode and a cathode, each coupled to a different, opposing voltage, and a gap there between, through which wastewater flows. Some embodiments may include electrode assemblies with different metals to address different contaminants having different electrochemical properties. For instance, some embodiments may include a series of (e.g., three) assemblies with aluminum electrodes and then a series of (e.g., three) assemblies with iron or steel electrodes. In some embodiments, the anode and the cathode of a given set of electrodes are arranged in parallel electrical connections to power generators 610, such that one electrode is positively charged while the other is negatively charged. In some cases, the current flow across the electrodes may be between 100 and 200 amps, and voltage range is typically in the range of 10-15 volts for each EC cell. Current is set according to the conductivity of the input water.

In some embodiments, electrodes in the electrode assemblies may include interdigitated electrodes that define a serpentine (and serial) path through the respective assembly. In some cases, the fluid may flow from one end of the assemblies to the other and back, extending the distance over which the fluid is proximate the plates relative to systems that pass fluid between plates in parallel flow paths such that there is no by-pass of the wastewater around the electrical current/voltage field and that all individual units of water are effectively treated. This is expected to facilitate a relatively compact, power efficient design that accommodates remote, power-constrained use cases. That said, not all embodiments provide this advantage, as other features are independently useful.

In operation, the anode metal plate may corrode due to oxidation and the cathode may be subjected to passivation, which is expected to cause destabilization of the particles present in the wastewater, and which is expected to facilitate separation of the metals and solids in the water via coagulation. In some embodiments, the wastewater treated by the electrocoagulation unit may include a floating layer, clear water, and a heavy sediment layer, as a result of coagulants dropping out of the wastewater. The electrocoagulation unit may include a collection tank at the bottom of the unit to collect the heavy sediment layer.

As illustrated by FIG. 1, in some embodiments, the electrocoagulation unit may include one or more sensors 18 configured to convey information related to parameters of wastewater within the electrocoagulation unit. For example, some sensors may measure wastewater flow rate, pH level, power density, or other parameters. In some embodiments, electrocoagulation unit may include a feedback controller 19. Feedback controller 19 may be configured to receive information from sensor 18, compare the information received with one or more target values (predetermined or dynamically determined) corresponding to the information received, and adjust parameters of the electrocoagulation unit based on the comparison between the values and the measurements from the sensor. For example, feedback controller may be configured to adjust the wastewater flow rate, the power density, the pH of the wastewater based on measurement from sensor 18. In some cases, a microcontroller coupled to a variable pump, adjustable valve, or current controller may execute proportional; proportional-derivative control; or proportional-integral-derivative control over the water flow rate or other parameters of the electrocoagulation unit in response to measured readings from sensor 18. Feedback controller 19 may be an open-loop type feedback controller, a closed-loop type feedback controller, or other types of controllers.

In some cases, the power applied to the electrodes may be direct current power. In other embodiments, alternating current power may be applied. In some cases, the alternating current power may have a generally square (e.g., generally rectangular, depending on how time is scaled relative to amplitude) wave pattern centered about ground. In some cases, the duty cycle may be approximately 1 second, 1 minute, 10 minutes, or once per day, depending upon tradeoffs between wear on electrical components and desired evenness of wear on electrodes. Alternating the current is expected to balance consumption of the electrodes, thereby extending the duration between maintenance events and facilitating uses in remote areas away from additional supplies of electrodes.

Mobile flocculation unit 110 may be configured to be fluidly coupled with the electrocoagulation unit. In some embodiments, mobile flocculation unit 110 may be configured to be fluidly coupled with other components of continuous-process mobile station 100. Mobile flocculation unit 110 may be configured to receive the treated wastewater from the electrocoagulation unit. In some embodiments, mobile flocculation unit 110 may be configured to cause suspended particles to form flocs. In some cases, the suspended particles are relatively small solid particles that are in suspension in the wastewater as colloids. Mobile flocculation unit 110 may include one or more mixing tanks configured to cause the suspended particles to come out of suspension and form of flocs by mixing the received waste water with a coagulant. For example, the coagulants may include organic polymers or inorganic coagulants such as alum.

In operation, in some embodiments, a coagulant is added during mixing of the wastewater to encourage destabilization of the particles, followed by relatively gentle mixing for encouraging the formation of flocs. In some embodiments, mobile flocculation unit 110 may include a settling tank configured to receive the floc of suspended particles. In some embodiments, continuous-process mobile station 100 may include one or more filters configured to remove the flocs of suspended particles from the settling tank. In some embodiments, removing the flocs includes removing some but not all the flocs. An example of the one or more filters may be a filter press. The filter press may be a membrane filter press, an automatic filter press, a recessed plate filter press, or other types of filter presses. The filter press may include one or more of plates, frames, pumps, filter cloths, or other components. The wastewater including the flocs of suspended particles may be injected into the press and through the filter cloths causing the flocs to form filter “cakes” that can be disposed of

In some embodiments, mobile flocculation unit 110 may include a DAF (dissolved air floatation) unit to remove floating flocs. The dissolved air floatation (DAF) unit may be configured to separate the flocs out of the water by floating the flocs to the surface. In some embodiments, the dissolved air floatation (DAF) unit may be configured to introduce air bubbles to create additional buoyancy and float the floc. In some embodiments, flocculation unit may include a feedback controller 20 and sensor 21. Feedback controller may be configured to receive information form sensor 21, compare the information received with one or more values corresponding to the information received, and adjust parameters of the flocculation unit based on the comparison between the predetermined values and the actual measurements form the sensor. In some cases, a microcontroller coupled to a variable pump, adjustable valve, or current controller may execute proportional; proportional-derivative control; or proportional-integral-derivative control over the water flow rate or other parameters of the flocculation unit in response to measured readings. Feedback controller 20 may be an open-loop type feedback controller, a closed-loop type feedback controller, or other types of controllers. Such parameters may include mixing speeds, mixing intensity, mixing time, amount of coagulant, or other parameters (again, which is not to imply that any other list is intended to exclude non-enumerated items).

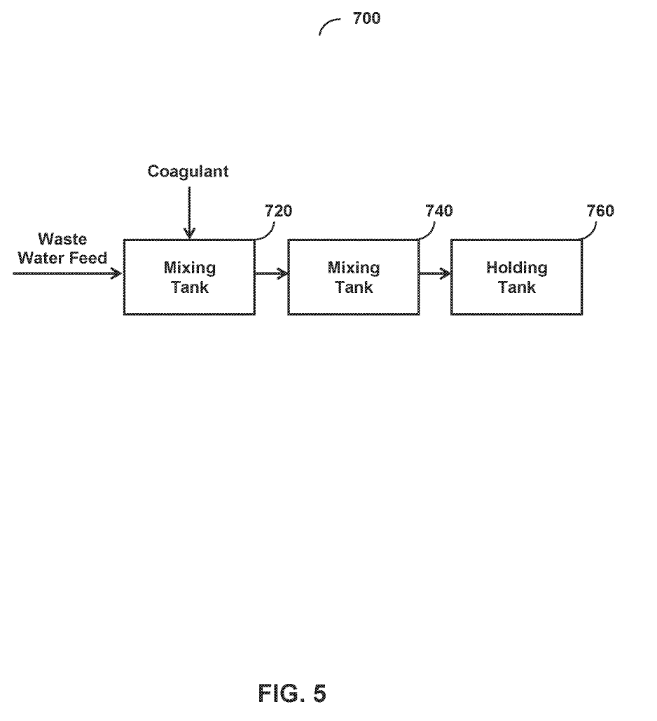

FIG. 5 shows an example of a flocculation unit 700 including a first mixing tank 720, a second mixing tank 740, and a holding tank 760.

In some embodiments, depending on the consumer of the treated water, the water is further subjected to additional filtration steps after removal of the suspended particles. For example, continuous-process mobile station 100 may include filters 112 configured to remove remaining suspended particles, salts or other remaining impurities and holding tank 114 configured to receive water from filters 112. In some embodiments, filters 112 may include a solid/liquid separation system for example, a filter press, and/or a bag filter. Water resulting from the filtration process may be reused in hydraulic fracturing activities, or may be subjected to further filtration (for example, reverse osmosis to remove salts) for use in other application (for example, for agricultural use). In some embodiments, removing the suspended particles includes removing some but not all the suspended particles. In some embodiments, filters 112 may include a feedback controller 23 and sensor 22. Feedback controller 23 may be configured to receive information form sensor 22, compare the information received with one or more values corresponding to the information received, and adjust parameters of the filtration unit 112 based on the comparison between the predetermined values and the actual measurements form the sensor 22.

In some embodiments, continuous-process mobile station may be configured to control one or more wastewater operations described above through process control. For example, continuous-process mobile station 100 may be configured to control flow rates, tank levels, pressures, temperatures and power parameters, pH parameters, or other parameters of other variables associated with continuous-process mobile station 100 using controller 120 (shown in FIG. 1).

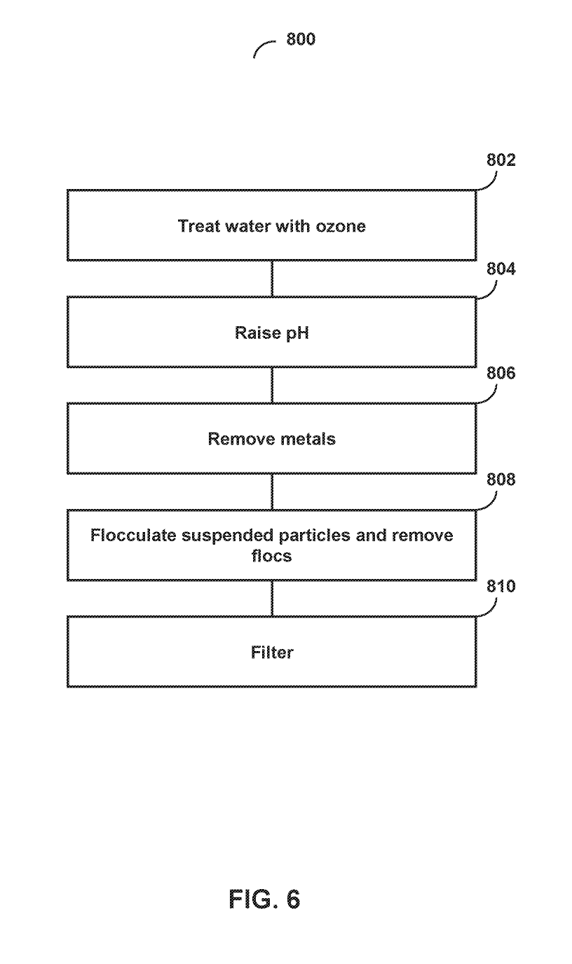

FIG. 6 illustrates a process 800 for treating wastewater using a continuous-process mobile station in accordance with one or more embodiments, like (but not limited to) those described above. The operations of process 800 presented below are intended to be illustrative, which is not to imply that the above discussion is intended to be limiting. In some embodiments, process 800 may be accomplished with one or more additional operations not described or without one or more of the operations discussed, which is not to imply that any other component is limited to the features described. Additionally, the order in which the operations of process 800 are illustrated in FIG. 6 and described below is not intended to be limiting, which is not to imply that any other component is limited to the features described.

At an operation 802, in some embodiments, wastewater is treated with ozone gas to breakdown impurities. In some embodiments, ozone is generated with an ozone gas generator and ozone gas is injected through one or more venturis at a pressure between 20 and 70 psi. In some embodiments, ORP of wastewater may be measured by an ORP sensor, and flowrate of wastewater is variable based on a predetermined water ORP range value. In some embodiments, ozone gas concentration and quantity per unit of wastewater is varied based on predetermined water ORP range value. In some embodiments, operation 802 may be performed by a mobile ozonation unit the same as or similar to mobile ozonation unit 104 (shown in FIG. 1 and described herein).

At an operation 804, pH of the wastewater is raised. In some embodiments, operation 604 may be performed by a pH control unit the same as or similar to pH control unit 106 (shown in FIG. 1 and described herein).

At operation 806 solids and metals are separated from the treated wastewater. In some embodiments, operation 806 may be performed by an electrocoagulation unit the same as or similar to electrocoagulation unit 108 (shown in FIG. 1 and described herein).

At operation 808 suspended particles flocculate to form flocs. In some embodiments, the formed flocs are removed for the treated water. In some embodiments, operation 808 may be performed by a flocculation unit the same as or similar to flocculation unit 110 (shown in FIG. 1 and described herein).

At operation 810, water may be further filtered. In some embodiments, the water may be filtered to remove salts, or other small suspended particles. In some embodiments, operation 808 may be performed by filters the same as or similar to filters 112 (shown in FIG. 1 and described herein).

In some embodiments, the process 800 may include producing oil or gas along with waste water, e.g., prior to the first illustrated step. Further, some embodiments may include the hydraulic fracturing of a well, transporting a mobile station like that of FIG. 1 to a well site and setting up the station, and coupling the station to the well. Some embodiments may include delivering treated water to a recipient, e.g., by storing treated water in a holding tank or pond, pumping the water in to a tanker truck, driving the truck to an agricultural facility, and applying the water to crops (or otherwise reusing the treated water). It should be understood that removing contaminants, metals, or other impurities includes removing some, but not necessarily 100%.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the accompanying drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning “having the potential to”), rather than the mandatory sense (i.e., meaning “must”). The words “include,” “including,” and “includes,” and the like, mean “including, but not limited to.” As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,” “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification, discussions utilizing terms such as “processing,” “computing,” “calculating,” “determining,” and/or the like, refer to actions or processes of a specific apparatus, such as a special purpose computer or a similar special purpose electronic processing/computing device.

We claim:

1. A continuous-process mobile station for treating wastewater, the mobile station comprising:
one or more mobile units configured to receive a feed of wastewater, the one or more mobile units comprising:
a mobile ozonation unit configured to treat the received feed of wastewater with ozone gas to breakdown impurities in the wastewater;
a mobile pH control unit configured to be fluidly coupled with the ozonation unit, the pH control unit being configured to raise pH of the treated wastewater;
a mobile electrocoagulation unit configured to be fluidly coupled with the pH control unit, the electrocoagulation unit configured to receive the treated wastewater from the mobile pH control unit, the mobile electrocoagulation unit including one or more pairs of electrodes and an insulating material, wherein the electrodes are configured to remove metals from the treated wastewater; and
a mobile flocculation unit configured to be fluidly coupled with the electrocoagulation unit, the flocculation unit being configured to receive the treated wastewater from the electrocoagulation unit cause suspended particles in the treated wastewater to form flocs wherein the mobile flocculation unit is configured to facilitate removal of the flocs from the received treated water.

2. The continuous-process mobile station of claim 1, wherein the one or more mobile units are modular units sized to fit on a truck and be unloaded by a forklift, and wherein the flow rate of the wastewater is between 30-120 gallons/min.

3. The continuous-process mobile station of claim 1, wherein flowrate is greater than or equal to 30,000 gallons of wastewater a day.

4. The continuous-process mobile station of claim 1, wherein one or more mobile units are removably coupled to one another.

5. The continuous-process mobile station of claim 1, comprising an oil well coupled to an inlet of the mobile treatment unit.

6. The continuous-process mobile station of claim 1, wherein the one or more mobile units further comprise an oil separator unit; the oil separator unit configured to separate oil from the wastewater prior to further treatment.

7. The continuous-process mobile station of claim 1, wherein the one or more mobile units further comprise an advance filtration system to remove salt from the wastewater.

8. The continuous-process mobile station of claim 1, further comprising one or more feedback controllers configured to control pH of the wastewater.

9. The continuous-process mobile station of claim 1, further comprising one or more feedback controllers configured to control ozone gas parameters.

10. The continuous-process mobile station of claim 1, wherein the ozonation unit comprises an ozone gas generator configured to generate ozone gas, and wherein the ozone gas is injected through one or more venturis at a pressure at least between 20 and 45 psi.

11. The continuous-process mobile station of claim 1, further comprising an oxidation reduction potential (ORP) sensor configured to measure oxidation reduction potential (ORP) of the wastewater, and wherein the continuous-process mobile station is configured to adjust the wastewater flow rate based on a target outlet oxidation reduction potential (ORP) value.

12. The continuous-process mobile station of claim 1, further comprising an oxidation reduction potential (ORP) measurement device configured to measure water oxidation reduction potential (ORP), and wherein the continuous-process mobile station is configured to adjust the ozone gas delivery concentration and volume per unit water based on a target outlet oxidation reduction potential (ORP) value.

13. The continuous-process mobile station of claim 1, wherein the flocculation unit comprises a mixing unit configured to mix the received wastewater with an amount of a coagulant and either a settling tank configured to receive the floc of suspended particles, a dissolved air floatation (DAF) unit to remove floating flocs, or both a dissolved air floatation (DAF) unit and a settling tank.

14. A method for treating wastewater that is continuous and suitable for remote, temporary mobile applications, the method comprising:
infusing a received feed of wastewater with ozone gas to breakdown impurities in the wastewater;
raising pH of the wastewater;
electrocoagulating solids and metals in the wastewater; and
causing suspended particles to form flocs and removing the flocs from the received wastewater.

15. The method of claim 14, comprising:
transporting a plurality of modular units on one or more trucks;
assembling the modular units into a water treatment station,
wherein the flow rate of the wastewater is between 20-120 gallons/min.

16. The method of claim 14, further comprising treating a quantity of wastewater that is greater than or equal to 30,000 gallons of wastewater a day.

17. The method of claim 14, comprising:
disassembling the units;
loading the units onto another truck;
transporting the units to a different location; and
treating a different stream of wastewater at the different location with the units.

18. The method of claim 14, comprising producing oil or gas and the wastewater from a well.

19. The method of claim 14, further comprising separating oil from the wastewater.

20. The method of claim 14, further comprising removing salt from the wastewater.

21. The method of claim 14, further comprising:
sensing a parameter of the wastewater to indicate the pH of the wastewater;
comparing the sensed parameter to a target value; and
adjusting the pH in response to the comparison.

22. The method of claim 14, further comprising controlling ozone gas parameters.

23. The method of claim 14, further comprising:
generating ozone gas; and
injecting the generated ozone gas at a pressure at least between 20 and 70 psi.

24. The method of claim 14, further comprising:
measuring water oxidation reduction potential (ORP); and
controlling wastewater flow rate based on a predetermined water oxidation reduction potential (ORP) range value.

25. The method of claim 14, further comprising:
measuring water oxidation reduction potential (ORP); and
controlling ozone gas delivery concentration and volume per unit water based on a predetermined water oxidation reduction potential (ORP) range.

26. The method of claim 14, further comprising:
causing suspended particles to form flocs by mixing the received wastewater with predetermined amount of a coagulant;
moving the floc of suspended particles into a settling tank; and
removing the floating flocs of suspended particles.
